(19) United States
(12) Patent Application Publication
(10) Pub. No.: US 2018/0029736 A1
(43) Pub. Date: Feb. 1, 2018

(54) Changeover Device Applicable on Packaging Machines with Flexible Wrapping Material

(71) Applicant: PFM IBERICA PACKAGING MACHINERY S.A., Barcelona (ES)

(72) Inventor: Andrea Fioravanti, Barcelona (ES)

(21) Appl. No.: 15/550,346

(22) PCT Filed: Feb. 12, 2016
(86) PCT No.: PCT/EP2016/053038

§ 371 Date: Aug. 10, 2017

(30) Foreign Application Priority Data
Feb. 27, 2015 (IT) VR2015A000034

(51) Int. Cl. B65B 59/00; B65B 9/20; G05B 19/418; B65B 65/00

(52) U.S. Cl. CPC B65B 59/00; B65B 65/003; B65B 9/20; G05B 19/4188; G05B 2219/31001; G05B 2219/50388

(57) ABSTRACT

A changeover device for an intermittent packaging machine with wrapping material constituted by a flexible film for successive welding, forming and work operations of envelopes for containing the packed product, comprises a plurality of mobile stations at adjustable interdistances, designed for performing, in succession, operations of welding, forming and processing of the envelopes (including different envelope formats), each of which is constituted by a substantially vertically-arranged frame, slidably positioned on fixed guide rails. The machine is equipped with a changeover device in which each single station is provided with a brake group able to maintain the single station blocked in a predetermined position along all the work line. Moreover, the adjustment of the interdistance between the stations is accomplished by a motorised shuttle which moves by a linear actuator along the processing line. The shuttle can comprise a sensor, an engaging device, and a brake release device.

### TECHNICAL FIELD

This invention relates to a changeover device applicable to packaging machines with intermittent feed with flexible wrapping material for the operations, in succession, for welding, forming and working envelopes designed for containing the packaged product.

The device according to this invention applies mainly, even if not exclusively, to HFFS (horizontal form fill seal) packaging machines which process various loose food products, such as grated cheese, mozzarella pearls, dog pellets, pasta or other products, which are loaded vertically.

According to the invention the system allows the control and the management of the relative and absolute positioning of the various stations along a working line on which they have freedom of movement by means of recirculating ball screw runners.

The device which determines the variation in the spacing of the envelopes acts simultaneously on the cutting and welding groups positioned on suitable sliding rails positioned on longitudinal supporting members.

The invention applies in the mechanical engineering industry applied to packaging machines, in particular to automatic packaging machines in food product lines.

### BACKGROUND ART

Use is known in the packaging sector of packaging machines which form part of a system which is able to automatically place products, such as food products but also other products, in envelopes and boxes, using automatic packaging lines.

The products to be packaged are automatically sent towards packaging lines which use horizontal or vertical packaging machines, of the flow-pack and HFFS type (horizontal form fill seal), which make closed packs, generally with three seals, of various products mainly loose, such as grated cheese, mozzarella pearls, dog pellets and pasta, with vertical loading, starting from a reel of hot or cold sealing wrapping material consisting of a flexible film.

The packaging machines may in general also be very different from each other, but all have in common the aim of placing the product in envelopes, starting from a reel of heat-sealing wrapping material, and conveying it towards the boxing sector.

One of the problems encountered with the use of these packaging machines regards the possibility of having to package batches of products of different size which can be placed in packages having differing dimensions from one size to the other.

This possibility, which is also very common especially in the case of various loose products such as grated cheese, mozzarella pearls, dog pellets and pasta, which are loaded vertically, results in some practical difficulties, during the steps for changing the format of the envelopes, as on one hand it is necessary to use skilled personnel working manually and even with lengthy process times, and on the other hand there is a certain degree of imprecision in the setting up of the formats.

In effect, traditional packaging machines, especially those with a high productivity, are equipped with a plurality of the forming, welding, cutting and pulling groups, which, in the event of change of size of the envelope used for the packaging, due, precisely, to the change of size of the product to be packaged, must be moved one at a time to change from the dimensions of the previous format to that necessary for to the subsequent working.

In some cases, certain automatic devices are used with the aim of mechanising the changeover process, however their efficiency has been found to be rather limited and poor, and not able to guarantee the necessary precision.

Currently, in effect, some manufacturers install, for example, a system with a relatively simple design for movement of the various stations and only for a limited number of stations, typically those for welding.

The system for movement of the stations which is used in some cases connects the movable stations with a single “drive unit”, for example a threaded bar, which moves them simultaneously so as to modify the spacing.

A problem found using this solution is the fact that the movement is only relative between one station and the other and it is not possible to move a single station.

This represents a significant limitation since small adjustments on the individual stations are not allowed in order to correct the inevitable imprecisions of the packaging machines.

A further problem found is that relative to the limited effectiveness, since this type of semi-automatic adjustment is applicable to a limited number of stations since they must be interconnected by the drive unit.

### DESCRIPTION OF THE INVENTION

The aim of this invention is to provide a changeover device, applicable to intermittent advancement packaging machines with wrapping material constituted by a flexible film, which allows the control and management of the relative and absolute positioning of the various stations along a working line on which they have freedom of movement, for example, by means of recirculating ball screw runners, thereby creating a condition which is able to eliminate or at least drastically reduce the above-mentioned drawbacks.

The invention also aims to provide a changeover device which is able to operate automatically on the adjustment of all the stations in very quick succession, making this operation extremely simple, fast and precise.

This is achieved by means of a changeover device applicable to the intermittent packaging machines with flexible wrapping material, the features of which are described in the main claim.

The dependent claims of the solution according to this invention describe advantageous embodiments of the invention.

The main advantages of this solution relate to the fact that, on the one hand, this device allows the format of envelopes of packaging machines to be changed in a fully automatic fashion, referring simply to a set of instructions stored on the control panel, without mechanical intervention by the operator, and, on the other hand, also allows micro-adjustments of the position of the stations, if necessary, thanks to the accuracy and repeatability of the movement.

### DESCRIPTION OF THE DRAWINGS

Other features and advantages of the invention will become clear on reading the description given below of one embodiment, provided as a non-limiting example, with the help of the accompanying drawings, in which:

FIG. 1 is a schematic view of a packaging machine with intermittent movement according to the invention of the type with flexible wrapping material;

FIG. 2 is a schematic side view of the packaging machine with intermittent movement of the type with flexible wrapping material of the previous figure;

FIG. 3 is a schematic top view of the packaging machine with intermittent movement in the preceding figures;

FIG. 4 is a front view of one of the various stations along a working line on which they have freedom of movement by means of recirculating ball screw runners;

FIG. 5 is another front view of one of the various stations represented on a different vertical cross-section plane;

FIG. 6 is a further front view of one of the stations represented on a different vertical cross-section plane;

FIG. 7 shows a detail of the lock and release unit of the sliding carriage of each of the stations.

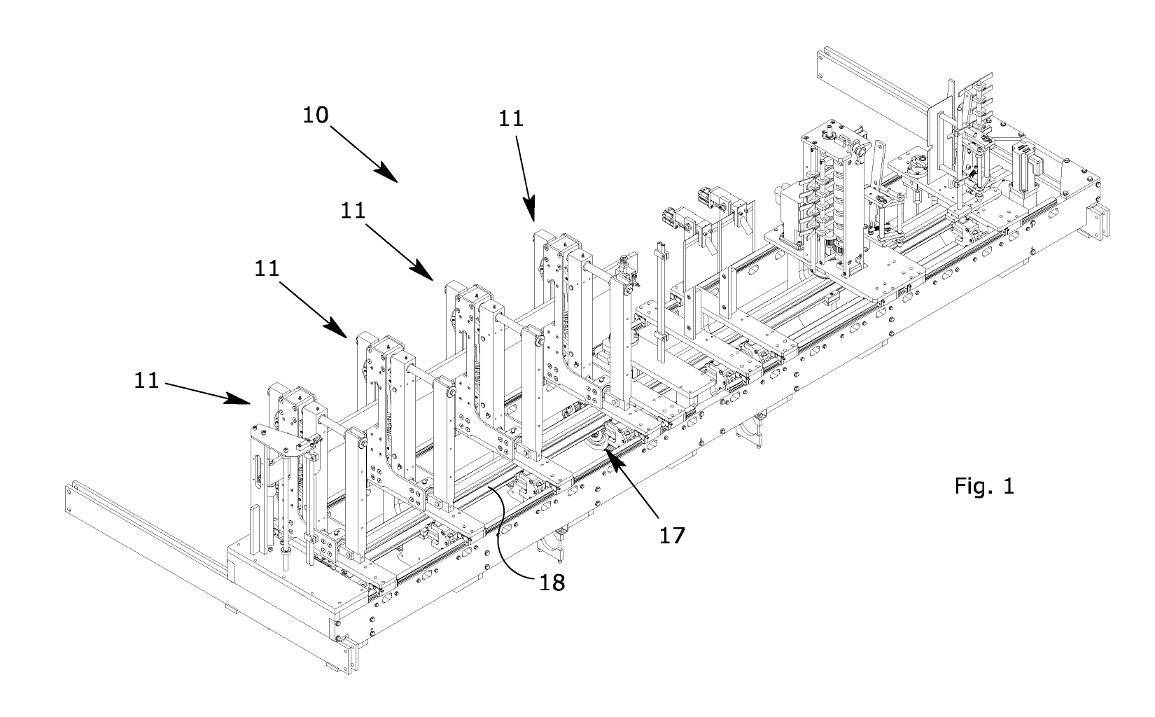

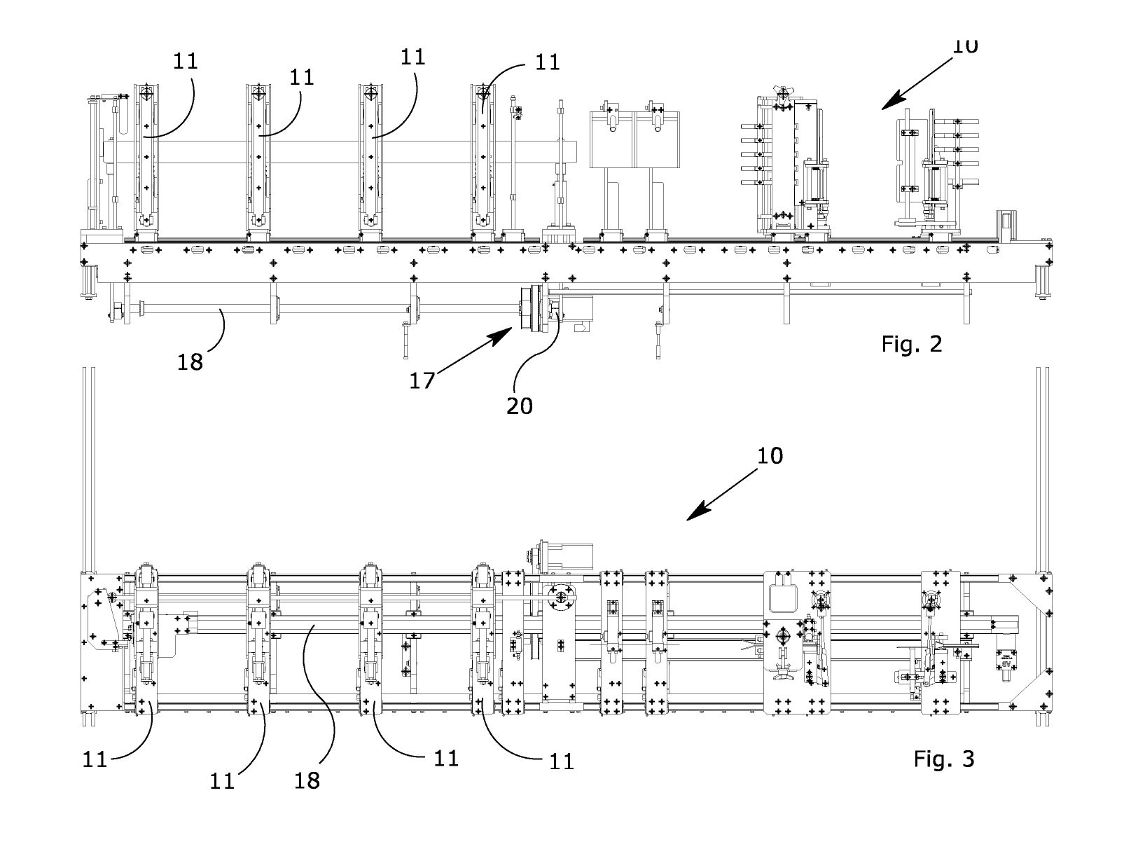

### DESCRIPTION OF AN EMBODIMENT OF THE INVENTION

With reference to the accompanying drawings, the numeral 10 denotes in its entirety a packaging machine of the “HFFS” type (horizontal form fill seal), that is an automatic packaging machine which uses a single reel of film for the packaging by applying three seals, two lateral and one horizontal, which can be used mainly, although not exclusively, in the food sector.

More specifically, the packaging machine 10 is designed to perform consecutive and automatic packaging of the product using flexible wrapping material, and therefore comprises a series of movable stations, labelled 11, designed to perform operations, in succession, for welding, forming and working envelopes even of a different size.

According to the invention the system allows the control and the management of the relative and absolute positioning of the various stations 11 movable along a working line on which they have freedom of movement by means of recirculating ball screw runners.

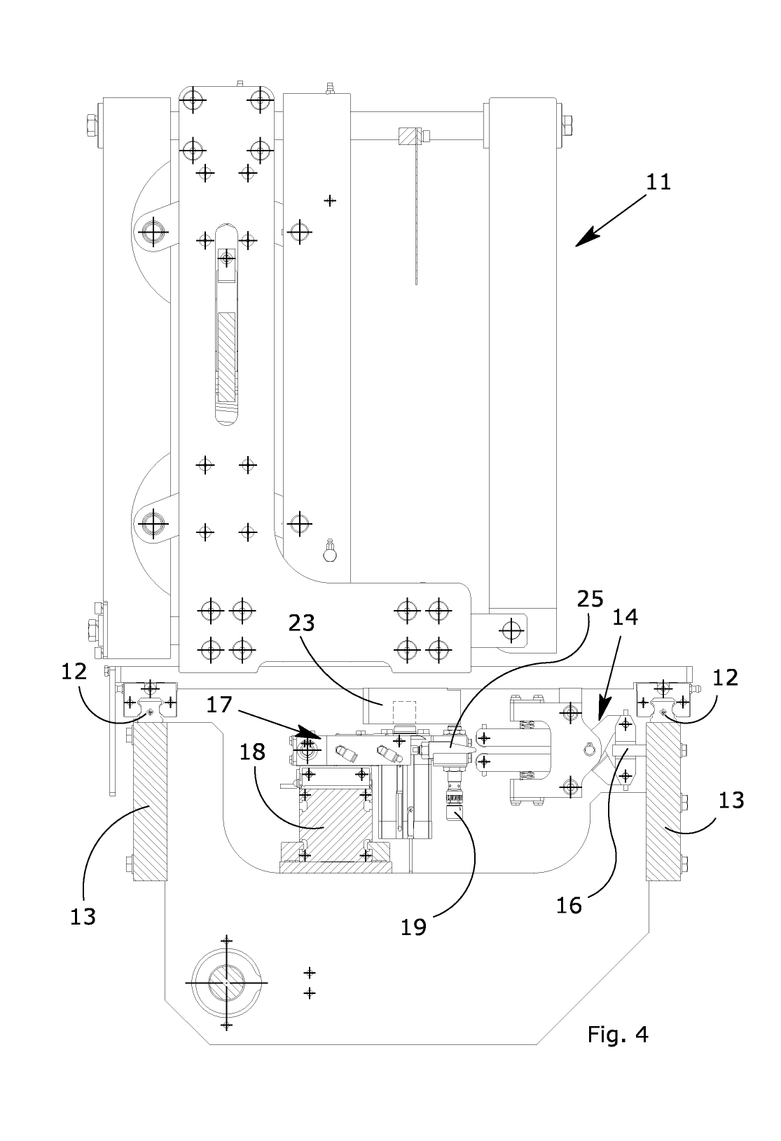

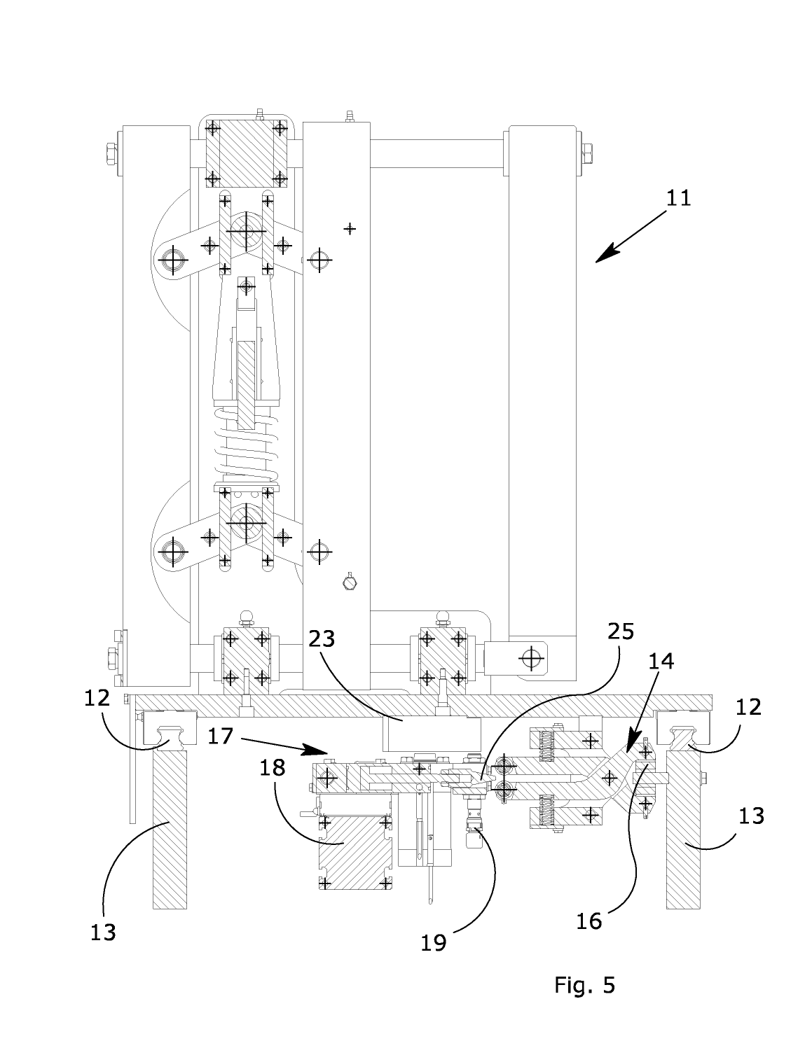

More specifically (see in particular FIG. 4), each of the stations 11, which represent the groups which can be adjusted depending on the size of the envelope, consists of a substantially vertical frame, positioned, with the possibility of sliding on recirculating ball screw runners, on guide rails 12, in turn positioned on horizontal supporting transversal members 13.

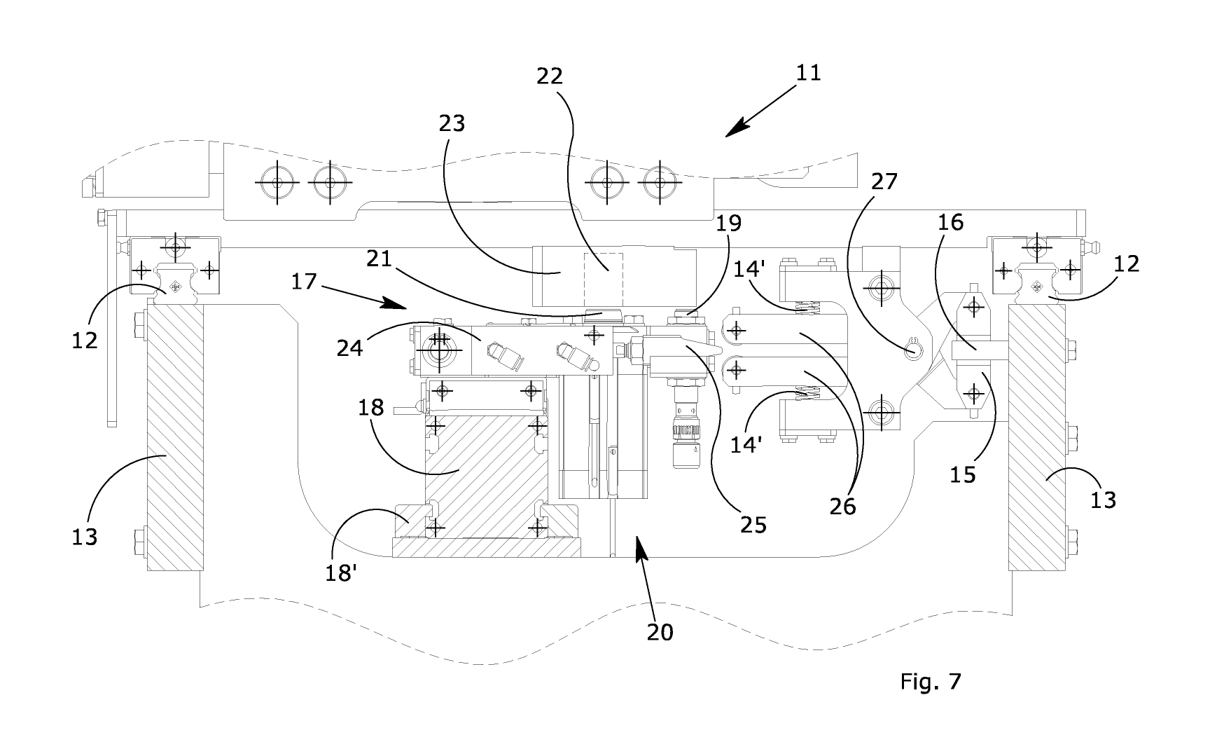

As illustrated in FIG. 7, each single station 11 is equipped with a brake group 14 with independent pliers and normally braked in opposition to springs 14′, whose pads 15 act on a bar 16 fixed to the frame common for all the stations and which extends along all the work line.

According to the invention the movement of the stations is achieved through a motorised shuttle 17 which moves on a linear actuator 18 along the working line.

The shuttle 17 is equipped with a sensor 19 for recognising the individual station 11 and a relative position thereof, a device 20, constituted by a pneumatic wedge-shaped cylinder, designed to release the brake 14 and a device for engaging the station for moving it.

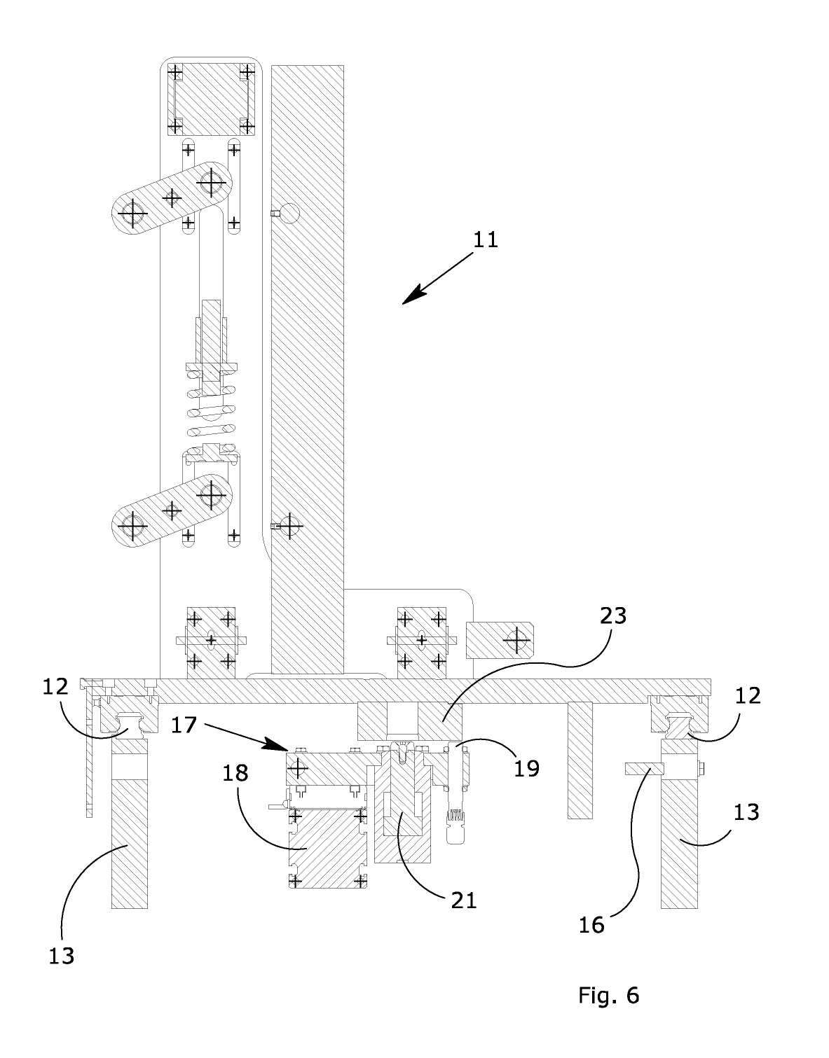

More in detail, the shuttle 17 which runs along the work guide 18′ and which is moved by the linear actuator 6, comprises (FIG. 6) an engaging device constituted by a cursor 21 having a shaft mobile on a vertical axis which intercepts and inserts in a respective seating 22 (FIG. 7) present in a shoe 23 present in the lower part of each station 11 when the sensor 19 has detected a presence and the position.

The same shuttle 17 also comprises a pneumatic cylinder 24, which moves on a horizontal axis a wedge 25 designed to spread two levers 26 forming part of the pliers 14 hinged on the pin 27.

From an operational point of view, when the shuttle 17 has positioned below the station 11 to be moved the sensor 19 controls the stopping at the shoe 23 allowing actuation of two simultaneous events:
a) vertical introduction of the cursor 21 in the seating 22 which constrains the shuttle to the station when the sensor 19 detects correct alignment thereof;
b) the simultaneous introduction horizontally of the wedge 25 between the two levers 26, which, on spreading, enable opening of the jaws 15 which deconstrain from the bar 16, freeing the brake of the station 11, enabling displacement thereof by means of the same shuttle that has deconstrained it.

The system is managed by a software interface which allows the position of the various stations to be defined in a very simple manner.

The operation sequence is such that firstly the operator defines on the control panel the positions of the stations or directly the size of the envelope to be made or refers to a combination previously stored.

The device then performs a reading sequence to check the actual position of the stations 11, making it possible to compensate for any accidental movements, and then moves one station at a time.

The shuttle 17 is positioned exactly beneath the station 11 to be moved, activates the station attachment device, consisting of the cursor 21, and the brake release device, consisting of the wedge 25 for opening of the jaws.

The shuttle imparts the programmed movement to the station 11 moving it by the extent necessary to the requested position (with an approximate degree of accuracy which can be assumed to be about 0.5 mm) and then re-engages the brake and releases the station, proceeding to the movement of the other stations.

The system makes it possible to move one station at a time but with the advantage of having a single smart shuttle which makes it possible to adjust all the stations in succession and fully automatically, with a clear reduction in the length of adjustment times and with an excellent precision.

The operation occurs with the machine stopped, since it is not possible to move a station whilst it is working.

This device allows the operations to be performed for changing the format of envelopes of packaging machines in a fully automatic fashion, referring simply to a recipe stored on the control panels, without having to request mechanical operations by the operator.

This also allows micro-adjustments to the position of the stations to be performed, if necessary, thanks to the accuracy and the repeatability of the movement.

The invention as described above refers to a preferred embodiment. It is nevertheless clear that the invention is susceptible to numerous variations which lie within the scope of its disclosure, in the framework of technical equivalents.

1. A changeover device for an intermittent packaging machine with wrapping material constituted by a flexible film for successive welding, forming and work operations of envelopes for containing the packed product, comprising:
a plurality of mobile stations at adjustable interdistances;
wherein each mobile station is configured for performing, in succession, operations of welding, forming and processing of the envelopes, even where the envelopes are of different formats;
wherein each mobile station further comprises:
a substantially vertically-arranged frame, slidably positioned on fixed guide rails; and
a brake group able to maintain a single station blocked in a predetermined position along all the work line (18′), wherein adjustment of the interdistance between the stations is realised by means of a motorized shuttle which moves by action of a linear actuator along the work line,
wherein the motorized shuttle further comprises:
a sensor connected to an appropriate software control program for recognising each single station and a relative position thereof,
an engaging device of the station able to move the station during the adjustment steps, and
a brake release device for disengaging the brake so as to enable translation of each single station and return each single station into the blocked position once adjustment is complete.

2. The device according to claim 1, wherein:
the brake group comprises independent pliers hinged on a pin and provided with a pair of pads activated in opposition to springs; and
the pads act on a bar fixed to the frame common for all the stations which extends along all the work line.

3. The device according to claim 1, wherein the shuttle which runs along the work guide and which is moved by the linear actuator, comprises:
an engaging device constituted by a cursor having a shaft mobile on a vertical axis which intercepts and inserts in a respective seating present in a shoe positioned in the lower part of each station when the sensor has detected a presence thereof and is the position is aligned.

4. The device according to claim 2, wherein the shuttle comprises:
a brake release device for each station constituted by a pneumatic cylinder (24), which moves a wedge on a horizontal axis for spreading two levers which are a part of the pliers hinged on the pin.

5. The device according to claim 3, wherein:
the sensor enables the shuttle to seek and trace each station to be adjusted, and thereafter determines a halting of the shuttle at the shoe, wherein halting of the shuttle causes actuation of two simultaneous events comprising:
(i) introduction of the cursor in the seating which constrains the shuttle to the station when the sensor detects correct alignment thereof; and
(ii) introduction horizontally of the wedge between the two levers, which, on spreading, enables opening of the jaws which deconstrain from the bar, freeing the brake of the mobile station, enabling displacement thereof by means of the same shuttle that has deconstrained it.

6. A changeover device for an intermittent packaging machine with wrapping material constituted by a flexible film for successive welding, forming and work operations of envelopes for containing a packed product, the machine comprising:
a plurality of mobile units placed at adjustable interdistances,
wherein each mobile unit is configured to perform in succession, operations of welding, forming and processing of the envelopes, even where the envelopes are of different formats;
wherein each mobile unit comprises:
a substantially vertically-arranged frame, slidably positioned on fixed guide rails; and
a brake for keeping said unit blocked in a predetermined position along a working line, whereby adjustment of the interdistance between the units is realized by means of a motorized shuttle moved by a linear actuator along the working line wherein the motorized shuttle further comprises:
a sensor connected to a software control program for identifying each unit and a relative position thereof;
a device for engaging and moving an unit during interdistance adjustment; and
a brake release device for disengaging the brake so as to enable translation of each unit and return each unit into a blocked position once interdistance adjustment is complete.

7. The device of claim 6, wherein:
the brake comprises independent pliers hinged on a pin and provided with a pair of pads activated in opposition to springs; and
the pads act on a bar fixed to the frame common for all the units which extends along the working line.

8. The device of claim 6, wherein the device for engaging and moving an unit during interdistance adjustment comprises:
a cursor having a shaft mobile on a vertical axis that is inserted in a seating made in a shoe positioned in the lower part of each unit when the sensor has detected a presence thereof and the positions of the shaft and of the seating are aligned to each other.

9. The device of claim 7, wherein the brake release device comprises:
a pneumatic cylinder for moving a wedge along a horizontal axis, thereby spreading apart two levers which are a part of the pliers hinged on the pin.

10. The device of claim 8, wherein the sensor and the software control program are configured to:
enable the shuttle to seek and trace each unit to be adjusted;
to subsequently stop the shuttle at the shoe; and
to introduce the shaft of the cursor into the seating, thereby clamping the shuttle to the unit.

11. The device of claim 9, wherein the software control program is further configured to introduce the wedge between the two levers, which, on spreading apart from each other, move the pads away from the bar, thereby and thereby releases the brake of the unit and allowing the shuttle to displace said unit.
